(19) United States
(12) Patent Application Publication
(10) Pub. No.: US 2026/0313735 A1
(43) Pub. Date: Oct. 8, 2026

(54) REMOTE CONTROL RECONNECTION METHOD AND APPARATUS, ELECTRONIC DEVICE, AND STORAGE MEDIUM

(71) Applicant: SHENZHEN XINGUODU TECHNOLOGY CO., LTD., Shenzhen, Guangdong (CN)

(72) Inventors: Yi FANG, Shenzhen (CN); Xiaoxin ZHOU, Shenzhen (CN); Hui LIN, Shenzhen (CN)

(21) Appl. No.: 19/485,170

(22) PCT Filed: Jun. 4, 2024
(86) PCT No.: PCT/CN2024/097311

§ 371 Date: Nov. 17, 2025

(30) Foreign Application Priority Data
Jun. 7, 2023 (CN) 202310674093.5

(51) Int. Cl. H04W 76/19

(52) U.S. Cl. CPC H04W 76/19

(57) ABSTRACT

A remote control reconnection method and apparatus, an electronic device, and a storage medium are provided. The method includes: acquiring a reconnection request sent by a target controlled terminal device, wherein the reconnection request carries a reconnection persistent connection address and a reconnection pairing mark; performing a matching determination on the reconnection pairing mark according to the reconnection persistent connection address and a preset pairing database, wherein the pairing database comprises an initial pairing mark and an initial control terminal device corresponding to the initial pairing mark; taking the initial pairing mark matching the reconnection pairing mark as a target pairing mark, and taking the initial control terminal device corresponding to the target pairing mark as a target control terminal device; and establishing a reconnection channel between the target control terminal device and the target controlled terminal device.

### TECHNICAL FIELD

The present disclosure relates to the technical field of remote control, and more particularly to a remote control reconnection method and apparatus, an electronic device, and a storage medium.

### BACKGROUND

At present, in Peer to Peer (P2P) communication or remote control scenarios, when a controlled terminal device experiences a weak network connection, network disconnection, etc., a user needs to manually establish remote control again. Alternatively, a control terminal device needs to use a new link address to connect to the controlled terminal device again. When the network connection is unstable, the above operation needs to be repeated many times, affecting the efficiency of remote control. Therefore, how to provide a remote control reconnection method to improve the remote control reconnection efficiency has become an urgent technical problem to be solved.

### SUMMARY

An objective of embodiments of the present disclosure is to provide a remote control reconnection method and apparatus, an electronic device, and a storage medium, to improve the remote control reconnection efficiency.

To achieve the above objective, in accordance with a first aspect of the present disclosure, an embodiment provides a remote control reconnection method, applied to a server and including:
acquiring a reconnection request sent by a target controlled terminal device, where the reconnection request carries a reconnection persistent connection address and a reconnection pairing mark;
performing a matching determination on the reconnection pairing mark according to the reconnection persistent connection address and a preset pairing database, where the pairing database includes an initial pairing mark and an initial control terminal device corresponding to the initial pairing mark;
determining the initial pairing mark matching the reconnection pairing mark as a target pairing mark, and determining the initial control terminal device corresponding to the target pairing mark as a target control terminal device; and
establishing a reconnection channel between the target control terminal device and the target controlled terminal device.

In some embodiments, before acquiring a reconnection request sent by a target controlled terminal device, the method further includes constructing the pairing database, including:
establishing a persistent connection with an initial controlled terminal device, generating an initial persistent connection address and the initial pairing mark, and sending the initial persistent connection address and the initial pairing mark to the initial controlled terminal device;
acquiring a remote control request from the initial control terminal device, where the remote control request carries a control persistent connection address and a control pairing mark;
establishing a persistent connection with the initial control terminal device according to the control persistent connection address, and performing a matching determination on whether the control pairing mark matches the initial pairing mark to obtain a control matching result;
in response to the control matching result indicating that the control pairing mark matches the initial pairing mark, establishing a control channel between the initial control terminal device and the initial controlled terminal device; and
constructing the pairing database according to the initial control terminal device, the initial controlled terminal device, and the initial pairing mark.

In some embodiments, the initial controlled terminal device that receives a disconnection signal is taken as the target controlled terminal device, and the reconnection request is generated by the target controlled terminal device in the following manner:
determining a disconnection status according to the disconnection signal; and
in response to the disconnection status indicating an abnormal disconnection, determining the initial persistent connection address as the reconnection persistent connection address, determining the initial pairing mark as the reconnection pairing mark, and generating the reconnection request according to the reconnection persistent connection address and the reconnection pairing mark.

In some embodiments, the reconnection request is sent by the target controlled terminal device in the following manner:
determining a disconnection type according to the disconnection signal, and in response to the disconnection type indicating a network disconnection, detecting a network state to obtain a detection result; and
sending the reconnection request in response to the detection result indicating a network recovery.

In some embodiments, the manner in which the target controlled terminal device sends the reconnection request further includes:
sending the reconnection request in a preset request time interval in response to the disconnection type indicating a non-network disconnection.

In some embodiments, before acquiring a reconnection request sent by a target controlled terminal device, the method further includes:
acquiring video stream data sent by the initial controlled terminal device, where the video stream data is generated by the initial controlled terminal device after acquiring a preset permission and generating a virtual display according to the preset permission; and
sending the video stream data to the initial control terminal device.

In some embodiments, establishing a reconnection channel between the target control terminal device and the target controlled terminal device includes:
acquiring a connection status of the target control terminal device; and
establishing the reconnection channel between the target control terminal device and the target controlled terminal device in response to the connection status indicating a connected status.

To achieve the above objective, in accordance with a second aspect of the present disclosure, an embodiment provides a remote control reconnection apparatus, applied to a server and including:
a reconnection request acquisition module configured for acquiring a reconnection request sent by a target controlled terminal device, where the reconnection request carries a reconnection persistent connection address and a reconnection pairing mark;
a matching determination module configured for performing a matching determination on the reconnection pairing mark according to the reconnection persistent connection address and a preset pairing database, where the pairing database includes an initial pairing mark and an initial control terminal device corresponding to the initial pairing mark;
a target control terminal device determining module configured for determining the initial pairing mark matching the reconnection pairing mark as a target pairing mark, and determining the initial control terminal device corresponding to the target pairing mark as a target control terminal device; and
a reconnection channel establishment module configured for establishing a reconnection channel between the target control terminal device and the target controlled terminal device.

To achieve the above objective, in accordance with a third aspect of the present disclosure, an embodiment provides an electronic device, including a memory, a processor, a program stored in the memory and executable by the processor, and a data bus configured for implementing connection and communication between the processor and the memory, where the program, when executed by the processor, causes the processor to implement the method in accordance with the first aspect of the present disclosure.

To achieve the above objective, in accordance with a fourth aspect of the present disclosure, an embodiment provides a storage medium, which is a computer-readable storage medium configured for computer-readable storage and has one or more programs stored therein, where the one or more programs, when executed by one or more processors, cause the one or more processors to implement the method in accordance with the first aspect of the present disclosure.

According to the remote control reconnection method and apparatus, the electronic device, and the storage medium provided in the present disclosure, a reconnection pairing mark is obtained according to a reconnection request sent by a target controlled terminal device, and the reconnection pairing mark is matched against a preset pairing database to obtain a corresponding target control terminal device. A reconnection channel is established between the target control terminal device and the target controlled terminal device. As such, a remote control reconnection between the target controlled terminal device and the target control terminal device is achieved. It can be seen that according to the remote control reconnection method provided in the embodiments of the present disclosure, the reconnection operation is performed by the target controlled terminal device and the server, and the target control terminal device does not need to perform any reconnection operation, such that the reconnection process is simplified, the remote control reconnection efficiency is improved, and the possibility of compromising the overall remote control system architecture and code structure. In practical applications, during the process from disconnection to successful reconnection, the target control terminal device can perceive the disconnection of a video stream, but does not need to perform any operation to restore the video stream, such that the remote control experience of the user is improved to a certain extent.

### BRIEF DESCRIPTION OF DRAWINGS

FIG. 1 is a flowchart of a remote control reconnection method according to an embodiment of the present disclosure;

FIG. 2 is a schematic diagram of a remote control system according to an embodiment of the present disclosure;

FIG. 3 is a schematic diagram of a pairing database according to an embodiment of the present disclosure;

FIG. 4 is a flowchart of constructing the pairing database according to an embodiment of the present disclosure;

FIG. 5 is a flowchart of a remote control reconnection method according to an embodiment of the present disclosure;

FIG. 6 is a flowchart of generating a reconnection request by a target controlled terminal device according to an embodiment of the present disclosure;

FIG. 7 is a flowchart of sending the reconnection request by the target controlled terminal device according to an embodiment of the present disclosure;

FIG. 8 is a flowchart of S104 in FIG. 1;

FIG. 9 is a schematic structural diagram of a remote control reconnection apparatus according to an embodiment of the present disclosure; and

FIG. 10 is a schematic structural diagram of hardware of an electronic device according to an embodiment of the present disclosure.

### DETAILED DESCRIPTION

To make the objectives, technical schemes, and advantages of the present disclosure clearer, the present disclosure is described in further detail with reference to accompanying drawings and embodiments. It is to be understood that the specific embodiments described herein are merely used for illustrating the present disclosure, and are not intended to limit the present disclosure.

It is to be noted, although functional modules have been divided in the schematic diagrams of apparatuses and logical orders have been shown in the flowcharts, in some cases, the modules may be divided in a different manner, or the steps shown or described may be executed in an order different from the orders as shown in the flowcharts. The terms such as “first,” “second” and the like in the description, the claims, and the accompanying drawings are used to distinguish similar objects, and are not necessarily used to describe a specific sequence or a precedence order.

Unless otherwise defined, meanings of all technical and scientific terms used throughout the context are the same as those generally understood by those having ordinary skills in the art to which the present disclosure belongs. Terms herein are merely intended to describe the embodiments of the present disclosure, but are not intended to limit the present disclosure.

At present, in Peer to Peer (P2P) communication or remote control scenarios, when a controlled terminal device experiences a weak network connection, network disconnection, etc., a user needs to manually establish remote control again. Alternatively, a control terminal device needs to use a new link address to connect to the controlled terminal device again. When the network connection is unstable, the above operation needs to be repeated many times, leading to a complex reconnection operation and affecting the efficiency of remote control. Therefore, how to provide a remote control reconnection method to improve the remote control reconnection efficiency has become an urgent technical problem to be solved.

In view of the above, embodiments of the present disclosure provide a remote control reconnection method and apparatus, an electronic device, and a storage medium, to improve the remote control reconnection efficiency.

The remote control reconnection method and apparatus, the electronic device, and the storage medium provided in the embodiments of the present disclosure will be described in detail through the following embodiments. The remote control reconnection method in the embodiments of the present disclosure is described first.

An embodiment of the present disclosure provides a remote control reconnection method. Referring to FIG. 1, the method is applied to a server and includes, but is not limited to, the following steps S101 to S104.

At S101, a reconnection request sent by a target controlled terminal device is acquired, where the reconnection request carries a reconnection persistent connection address and a reconnection pairing mark.

At S102, match determination is performed on the reconnection pairing mark according to the reconnection persistent connection address and a preset pairing database, where the pairing database includes an initial pairing mark and an initial control terminal device corresponding to the initial pairing mark.

At S103, the initial pairing mark matching the reconnection pairing mark is determined as a target pairing mark, and the initial control terminal device corresponding to the target pairing mark is determined as a target control terminal device.

At S104, a reconnection channel is established between the target control terminal device and the target controlled terminal device.

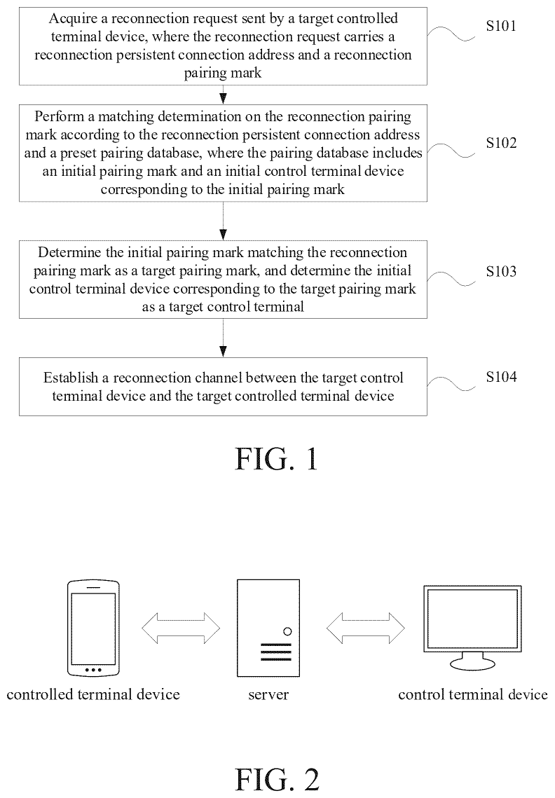

In some embodiments, in S101, referring to FIG. 2, a remote control system includes a controlled terminal device, a server, and a control terminal device, and the controlled terminal device and the control terminal device establish a remote control data transmission channel through the server, such that the control terminal device can remotely control the controlled terminal device. A method of establishing the remote control data transmission channel between the controlled terminal device and the control terminal device through the server will be described below. The target controlled terminal device is a controlled terminal device that has established a remote control data transmission channel with a control terminal device through the server in advance, but can no longer be remotely controlled due to disconnection or other reasons. The server acquires a reconnection request sent by the target controlled terminal device, where the reconnection request is intended for requesting to re-establish a remote control data transmission channel between the target controlled terminal device and a corresponding control terminal device, to restore remote control of the corresponding control terminal device over the target controlled terminal device. The method in which the target controlled terminal device generates the reconnection request will be described below. The reconnection request includes a reconnection persistent connection address and a reconnection pairing mark. The reconnection persistent connection address corresponds to an address of the controlled terminal device to establish a persistent connection with the server when establishing a remote control data transmission channel with the corresponding control terminal device in advance. The reconnection pairing mark is a mark used for matching the corresponding control terminal device in the reconnection operation. The reconnection pairing mark may be any one or more combinations of letters, digits, symbols, and the like. The length of the reconnection pairing mark is not particularly limited in the embodiments of the present disclosure. It can be understood that the reconnection request may further include a request identifier ‘reconnect-true’ to indicate that the current request is intended for requesting reconnection.

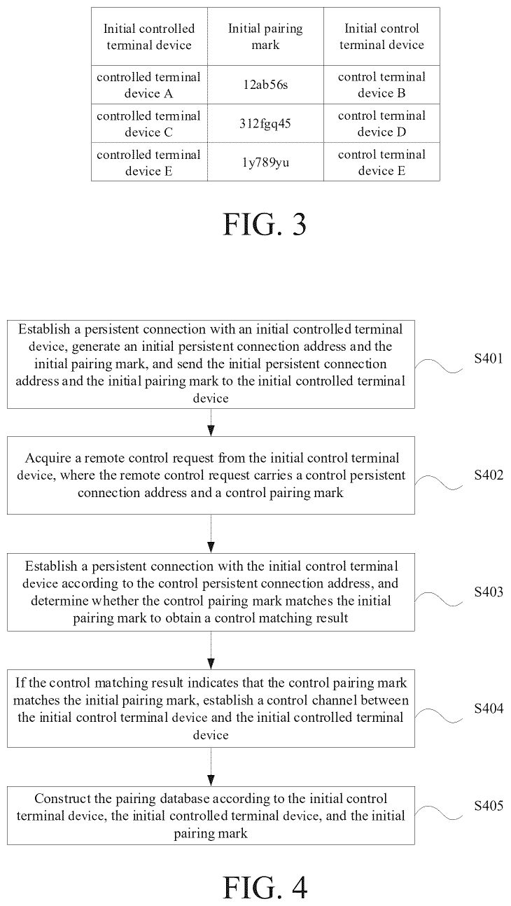

In some embodiments, in S102 to S103, referring to FIG. 3, the pairing database is a database constructed by the server according to pre-established remote control data transmission channels, and the pairing database includes initial pairing marks and respective initial control terminal devices. The server communicates with the target controlled terminal device according to the reconnection persistent connection address, compares the reconnection pairing mark with each of the initial pairing marks in the pairing database to perform match determination, determines the initial pairing mark matching the reconnection pairing mark as a target pairing mark, and determines the initial control terminal device corresponding to the target pairing mark as a target control terminal device. For example, when the reconnection pairing mark is ‘12ab56s’, a control terminal device B is determined as the target control terminal device. It can be understood that the pairing database may further include initial controlled terminal devices. By way of an example, it can be seen from FIG. 3 that a controlled terminal device A has established a remote control data transmission channel with the control terminal device B in advance, and an initial pairing mark corresponding to the controlled terminal device A and the control terminal device B is ‘12ab56s’. To improve the accuracy of matching, when match determination is performed on the reconnection pairing mark, a check can be performed on the target controlled terminal device, for example, check on whether the target controlled terminal device is the controlled terminal device A. Whether the target controlled terminal device is the controlled terminal device A may be determined by determining whether a MAC address of the target controlled terminal device is the same as a MAC address of the controlled terminal device A. When the reconnection pairing mark is ‘12ab56s’ and the MAC address of the target controlled terminal device is the same as the MAC address of the controlled terminal device A, the control terminal device B is determined as the target control terminal device.

In some embodiments, in S104, the server establishes a reconnection channel between the target control terminal device and the target controlled terminal device, i.e., re-establishes a remote control data transmission channel between the target control terminal device and the target controlled terminal device, thereby implementing a reconnection operation between the target controlled terminal device and the target control terminal device.

Through the operations S101 to S104 illustrated in the embodiments of the present disclosure, a reconnection pairing mark is obtained according to a reconnection request sent by a target controlled terminal device, and the reconnection pairing mark is matched against a preset pairing database to identify a corresponding target control terminal device. A reconnection channel is established between the target control terminal device and the target controlled terminal device. As such, a remote control reconnection between the target controlled terminal device and the target control terminal device is achieved. It can be seen that according to the remote control reconnection method provided in the embodiments of the present disclosure, the reconnection operation is performed by the target controlled terminal device and the server, and the target control terminal device does not need to perform any reconnection operation, such that the reconnection process is simplified, the remote control reconnection efficiency is improved, and the possibility of compromising the overall remote control system architecture and code structure. In practical applications, during the process from disconnection to successful reconnection, the target control terminal device can perceive the disconnection of a video stream, but does not need to perform any operation to restore the video stream, such that the remote control experience of the user is improved to a certain extent.

Referring to FIG. 4, in some embodiments, before S101, the remote control reconnection method provided in the embodiments of the present disclosure further includes constructing the pairing database, which includes, but is not limited to, the following steps S401 to S405.

At S401, a persistent connection is established with an initial controlled terminal device, an initial persistent connection address and the initial pairing mark are generated, and the initial persistent connection address and the initial pairing mark are sent to the initial controlled terminal device.

At S402, a remote control request from the initial control terminal device is acquired, where the remote control request carries a control persistent connection address and a control pairing mark.

At S403, a persistent connection is established with the initial control terminal device according to the control persistent connection address, and it is determined whether the control pairing mark matches the initial pairing mark to obtain a control matching result.

At S404, if the control matching result indicates that the control pairing mark matches the initial pairing mark, a control channel is established between the initial control terminal device and the initial controlled terminal device.

At S405, the pairing database is constructed according to the initial control terminal device, the initial controlled terminal device, and the initial pairing mark.

It can be understood that the construction of the pairing database is based on a remote control data transmission channel being established between the controlled terminal device and the control terminal device. Therefore, the method of establishing the remote control data transmission channel between the controlled terminal device and the control terminal device through the server will be described below in conjunction with the operations S401 to S405.

In some embodiments, in S401, the server establishes a persistent connection with the initial controlled terminal device through websocket or other means, and generates a corresponding initial persistent connection address and an initial pairing mark. The server sends the initial persistent connection address and the initial pairing mark to the initial controlled terminal device, and stores the initial pairing mark to establish a mapping relationship between the initial pairing mark and the initial controlled terminal device, e.g., a mapping relationship “controlled terminal device A—12ab56s”.

In some embodiments, in S402, assuming that a controlled terminal device that requires remote control is a terminal device to be controlled, a user acquires a control persistent connection address and a control pairing mark through a display interface of the terminal device to be controlled or other means, and inputs the control persistent connection address and the control pairing mark by an interface of the initial control terminal device, such that the initial control terminal device generates a remote control request according to the control persistent connection address and the control pairing mark. The server acquires the remote control request.

In some embodiments, in S403, the server establishes a persistent connection with the initial control terminal device according to the control persistent connection address, and performs a determination on whether the control pairing mark matches the saved initial pairing mark to obtain a corresponding control matching result. The control matching result is intended for determining whether the initial controlled terminal device is the terminal device to be controlled.

In some embodiments, in S404, if the control matching result indicates that the control pairing mark matches the initial pairing mark, it indicates that the initial controlled terminal device corresponding to the matching initial pairing mark is the terminal device to be controlled. A control channel is established between the initial control terminal device and the corresponding initial controlled terminal device, i.e., a remote control data transmission channel is established between the initial control terminal device and the corresponding initial controlled terminal device, such that the initial control terminal device can remotely control the initial controlled terminal device.

In some embodiments, in S405, a mapping relationship is established between the matching initial controlled terminal device, the initial control terminal device, and the corresponding initial pairing mark. For example, if the initial control terminal device in S402 is the control terminal device B, and the initial pairing mark matching the control pairing mark in S403 is ‘12ab56s’, a mapping relationship “controlled terminal device A—12ab56s—control terminal device B” is obtained. The pairing database is constructed according to the mapping relationship.

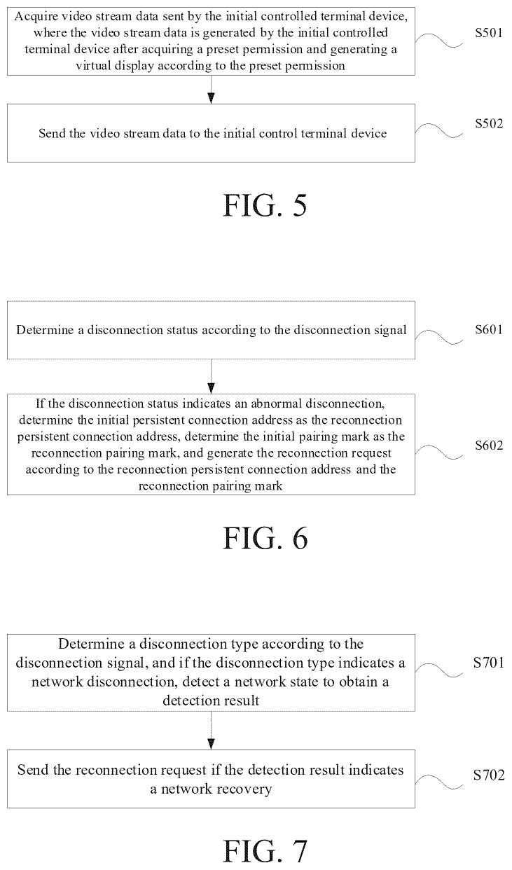

Referring to FIG. 5, in some embodiments, before S101, the remote control reconnection method provided in the embodiments of the present disclosure further includes, but is not limited to, the following steps S501 to S502.

At S501, video stream data sent by the initial controlled terminal device is acquired, where the video stream data is generated by the initial controlled terminal device after acquiring a preset permission and generating a virtual display according to the preset permission.

At S502, the video stream data is sent to the initial control terminal device.

It can be understood that after the mapping relationship is successfully established and a remote control data transmission channel is established between the initial control terminal device and the corresponding initial controlled terminal device, the initial control terminal device can remotely control the initial controlled terminal device. The remote control method will be described below in conjunction with the operations S501 to S502.

In some embodiments, in S501, the initial controlled terminal device acquires a preset permission. The preset permission is terminal device permissions corresponding to the video stream data, which, for example, includes network permission, screen recording permission, storage/writing permission, and the like. After acquiring the preset permissions, the initial controlled terminal device generates and saves a virtual display (VirtualDisplay). The initial controlled terminal device generates video stream data, and the server acquires the video stream data.

In some embodiments, in S502, the server sends the video stream data to the initial control terminal device, such that the video stream data can be displayed on an interface of the initial control terminal device, thereby realizing remote control.

In some embodiments, the initial control terminal device is further configured for generating a corresponding touch instruction in response to a touch operation performed by a user. The server acquires the touch instruction and sends the touch instruction to the initial controlled terminal device, such that the initial controlled terminal device responds to the touch instruction.

Referring to FIG. 6, in some embodiments, when a network disconnection or the like occurs, the websocket persistent connection is immediately interrupted, and the corresponding initial controlled terminal device is informed of the interruption, i.e., a disconnection signal is sent to the corresponding initial controlled terminal device. Therefore, the initial controlled terminal device receiving the disconnection signal is determined as the target controlled terminal device. The method in which the target controlled terminal device generates the reconnection request will be described in detail below. Referring to FIG. 6, the method in which the target controlled terminal device generates the reconnection request includes, but is not limited to, the following steps S601 to S602.

At S601, a disconnection status is determined according to the disconnection signal.

At S602, if the disconnection status indicates an abnormal disconnection, the initial persistent connection address is taken as the reconnection persistent connection address, the initial pairing mark is taken as the reconnection pairing mark, and the reconnection request is generated according to the reconnection persistent connection address and the reconnection pairing mark.

In some embodiments, in S601, the target controlled terminal device determines a disconnection status according to the disconnection signal, where the disconnection status is intended for indicating whether the disconnection is an abnormal disconnection. The abnormal disconnection includes network disconnection, failure to receive a response from the server, failure to receive a heartbeat signal for a long time, and the like.

In some embodiments, in S602, if the disconnection status indicates an abnormal disconnection, the target controlled terminal device takes the corresponding initial pairing mark as the reconnection pairing mark, and takes the corresponding initial persistent connection address as the reconnection persistent connection address. The target controlled terminal device generates the reconnection request according to the reconnection pairing mark and the reconnection persistent connection address.

The method in which the target controlled terminal device sends the reconnection request will be described below with reference to FIG. 7. In some embodiments, the method in which the target controlled terminal device sends the reconnection request includes, but is not limited to, the following steps S701 to S702.

At S701, a disconnection type is determined according to the disconnection signal, and if the disconnection type indicates a network disconnection, a network state is detected to obtain a detection result.

At S702, the reconnection request is sent if the detection result indicates a network recovery.

In some embodiments, in S701, the target controlled terminal device determines a disconnection type according to the disconnection signal, where the disconnection type includes a network disconnection or a non-network disconnection. The network disconnection is a disconnection caused by a network reason, e.g., a disconnection caused by the target controlled terminal device turning off Wi-Fi, the target controlled terminal device switching from Wi-Fi to network data traffic, etc. When determining that the disconnection type is a network disconnection, the target controlled terminal device performs voluntarily network state detection and obtains the detection result.

In some embodiments, in S702, if the detection result indicates a network recovery, it indicates that the current network state does not cause a disconnection, and therefore, the target controlled terminal device sends a reconnection request to the server to request to re-establish a remote control data transmission channel with the target control terminal device.

In some embodiments, the method in which the target controlled terminal device sends the reconnection request further includes:
sending the reconnection request in a preset request time interval if the disconnection type indicates a non-network disconnection.

For example, the non-network disconnection is a disconnection not caused by a network reason, and may be a disconnection caused by restart of the server, non-existence of a domain name, interception of a data transmission request by the server, etc. In this case, the target controlled terminal device sends the reconnection request in a preset request time interval, for example, sends the reconnection request once per 5 seconds. If the number of times the reconnection request is sent reaches a preset threshold, e.g., the reconnection request has been sent three times but the reconnection fails, the reconnection request will no longer be sent.

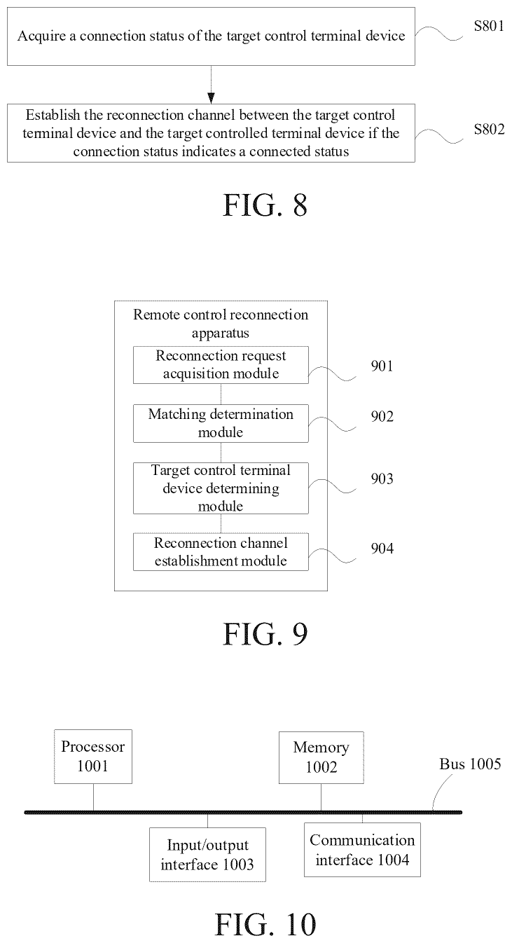

It can be understood that when the target controlled terminal device is disconnected, the video stream data cannot be sent to the corresponding target control terminal device. Therefore, when the target controlled terminal device resumes connection with the target control terminal device according to the reconnection request, transmission of the video stream data corresponding to the target controlled terminal device should also be resumed. Referring to FIG. 8, in some embodiments, S104 includes, but is not limited to, the following steps S801 to S802.

At S801, a connection status of the target control terminal device is acquired.

At S802, the reconnection channel is established between the target control terminal device and the target controlled terminal device if the connection status indicates a connected status.

In some embodiments, in S801, the connection status is indicative of a connection status between the target control terminal device and the server, and the server determines according to the connection status whether the target control terminal device still maintains a persistent connection with the server.

In some embodiments, in S802, if the connection status indicates a connected status, i.e., indicates that the target control terminal device still maintains a persistent connection with the server, the server establishes a reconnection channel between the target control terminal device and the target controlled terminal device. The server sends a touch instruction or the like of the target control terminal device to the target controlled terminal device, and informs the target controlled terminal device that the reconnection is successful. The target controlled terminal device generates new video stream data based on the virtual display saved before disconnection and the touch instruction from the target control terminal device, and sends the new video stream data to the server. The server forwards the new video stream data to the target control terminal device, thereby realizing remote control of the target control terminal device over the target controlled terminal device again.

It can be understood that if the connection status indicates a disconnected status, i.e., indicates that the persistent connection between the target control terminal device and the server is interrupted, reconnection cannot be performed, and the server informs the target controlled terminal device that the reconnection fails. In this case, if the target control terminal device still needs to remotely control the target controlled terminal device, a new remote control procedure needs to be initiated for the target control terminal device and the target controlled terminal device. The new remote control procedure is similar to the process described in S401 to S404, and the details will not be repeated in the embodiments of the present disclosure.

Referring to FIG. 9, an embodiment of the present disclosure further provides a remote control reconnection apparatus, which can implement the remote control reconnection method. The apparatus is applied to a server and includes:
a reconnection request acquisition module 901 configured for acquiring a reconnection request sent by a target controlled terminal device, where the reconnection request carries a reconnection persistent connection address and a reconnection pairing mark;
a matching determination module 902 configured for performing a matching determination on the reconnection pairing mark according to the reconnection persistent connection address and a preset pairing database, where the pairing database includes an initial pairing mark and an initial control terminal device corresponding to the initial pairing mark;
a target control terminal device determining module 903 configured for determining the initial pairing mark matching the reconnection pairing mark as a target pairing mark, and determining the initial control terminal device corresponding to the target pairing mark as a target control terminal device; and
a reconnection channel establishment module 904 configured for establishing a reconnection channel between the target control terminal device and the target controlled terminal device.

Specific embodiments of the remote control reconnection apparatus are basically the same as the specific embodiments of the remote control reconnection method, so the details will not be repeated herein.

An embodiment of the present disclosure further provides an electronic device, including a memory and a processor. The memory has a computer program stored therein. The computer program, when executed by the processor, causes the processor to implement the remote control reconnection method. The electronic device may include any smart terminal device such as a tablet computer or an in-vehicle computer.

FIG. 10 shows a hardware structure of an electronic device according to another embodiment. Referring to FIG. 10, the electronic device includes a processor 1001, a memory 1002, an input/output interface 1003, a communication interface 1004, and a bus 1005.

The processor 1001 may be implemented by a general-purpose Central Processing Unit (CPU), a microprocessor, an Application Specific Integrated Circuit (ASIC), or one or more integrated circuits, and is configured for executing a related program to implement the technical schemes provided by the embodiments of the present disclosure.

The memory 1002 may be implemented in the form of a Read Only Memory (ROM), a static storage device, a dynamic storage device, a Random Access Memory (RAM), etc. The memory 1002 may store an operating system and other application programs. The program codes related to the technical schemes of the present disclosure are stored in the memory 1002, and are called by the processor 1001 to execute the remote control reconnection method according to the embodiments of the present disclosure when the technical schemes provided by the embodiments of the present disclosure are implemented by software or firmware.

The input/output interface 1003 is configured for enabling input and output of information.

The communication interface 1004 is configured for realizing electrical communication interaction between the electronic device and other devices, either through wired communication (e.g., USB, network cable, etc.) or through wireless communication (e.g., mobile network, Wi-Fi, Bluetooth, etc.).

The bus 1005 is configured for transmitting information between components of the electronic device (such as the processor 1001, the memory 1002, the input/output interface 1003, and the communication interface 1004).

The processor 1001, the memory 1002, the input/output interface 1003, and the communication interface 1004 are in electrical communication connection with each other inside the electronic device via the bus 1005.

An embodiment of the present disclosure further provides a storage medium, which is computer-readable storage medium and stores a computer program which, when executed by a processor, causes the processor to implement the remote control reconnection method described above.

The memory, as a non-transitory computer-readable storage medium, may be configured for storing a non-transitory software program and a non-transitory computer-executable program. In addition, the memory may include a high-speed random access memory, and may also include a non-transitory memory, e.g., at least one magnetic disk storage device, flash memory device, or other non-transitory solid-state storage device. In some implementations, the memory may include memories located remotely from the processor, and the remote memories may be connected to the processor via a network. Examples of the network include, but are not limited to, the Internet, an intranet, a local area network, a mobile communication network, and combinations thereof.

The contents described in the embodiments of the present disclosure are for the purpose of illustrating the technical schemes of the embodiments of the present disclosure more clearly, and do not constitute a limitation on the technical schemes provided in the embodiments of the present disclosure. Those having ordinary skills in the art may know that with the evolution of technologies and the emergence of new application scenarios, the technical schemes provided in the embodiments of the present disclosure are also applicable to similar technical problems.

Those having ordinary skills in the art may understand that the technical scheme shown in the drawings does not constitute a limitation to the embodiments of the present disclosure, and more or fewer steps than those shown in the drawings may be included, or some steps may be combined, or different steps may be used.

The apparatus embodiments described above are merely examples. The units described as separate components may or may not be physically separated, i.e., they may be located in one place or may be distributed over a plurality of network units. Some or all of the modules may be selected according to actual needs to achieve the objectives of the schemes of the embodiments of the present disclosure.

Those having ordinary skills in the art can understand that all or some of the steps in the methods disclosed above and the functional modules/units in the system and the apparatus can be implemented as software, firmware, hardware, and appropriate combinations thereof.

In the specification and accompanying drawings of the present disclosure, the terms “first,” “second,” “third,” “fourth,” and so on (if any) are intended to distinguish between similar objects but do not necessarily indicate a specific order or sequence. It is to be understood that the data termed in such a way are interchangeable in appropriate circumstances, such that the embodiments of the present disclosure described herein can be implemented in orders other than the order illustrated or described herein. Moreover, the terms “include,” “comprise,” and any other variants thereof mean are intended to cover a non-exclusive inclusion. For example, a process, method, system, product, or device that includes a list of steps or units is not necessarily limited to those expressly listed steps or units, but may include other steps or units not expressly listed or inherent to such a process, method, product, or device.

It is to be understood that in the present disclosure, “at least one” means one or more and “a plurality of” means two or more. The term “and/or” is used for describing an association between associated objects and representing that three associations may exist. For example, “A and/or B” may indicate that only A exists, only B exists, and both A and B exist, where A and B may be singular or plural. The character “/” generally indicates an “or” relationship between the associated objects. “At least one of” and similar expressions refer to any combination of items listed, including one item or any combination of a plurality of items. For example, at least one of a, b, or c may represent a, b, c, “a and b,” “a and c,” “b and c,” or “a, b, and c,” where a, b, and c may be singular or plural.

In the several embodiments provided in the present disclosure, it is to be understood that the disclosed apparatus and method may be implemented in other manners. For example, the described apparatus embodiments are only illustrative. For example, the division of the units is merely a logical function division and other division manners may be used in practical implementations. For example, a plurality of units or components may be combined or integrated into another system, or some features may be ignored or not performed. In addition, the shown or discussed mutual couplings or direct couplings or communication connections may be implemented through some interfaces. The indirect couplings or communication connections between the apparatuses or units may be implemented in electronic, mechanical, or other forms.

The units described as separate parts may or may not be physically separate. Parts displayed as units may or may not be physical units, and may be located in one position, or may be distributed over a plurality of network units. Some or all of the units may be selected according to actual needs to achieve the objects of the scheme of the embodiments of the present disclosure.

In addition, various functional units in the embodiments of the present disclosure may be integrated into one processing unit, or each of the units may exist alone physically, or two or more units may be integrated into one unit. The integrated unit may be implemented in a form of hardware, or may be implemented in a form of a software functional unit.

The integrated unit may be stored in a computer-readable storage medium if implemented in the form of a software functional unit and sold or used as an independent product. Based on such an understanding, the technical schemes of the present disclosure essentially, or the part contributing to the related art, or all or some of the technical schemes may be implemented in the form of a software product. The software product is stored in a storage medium, and includes several instructions for instructing a computer device (which may be a personal computer, a server, a network device, or the like) to execute all or some of the steps of the methods described in the embodiments of the present disclosure. The storage medium includes: any medium that can store program code, such as a USB flash drive, a removable hard disk, a read-only memory (ROM), a random access memory (RAM), a magnetic disk, or an optical disk.

Although some embodiments of the present disclosure are described above with reference to the accompanying drawings, these embodiments are not intended to limit the protection scope of the embodiments of the present disclosure. Any modifications, equivalent replacements and improvements made by those having ordinary skills in the art without departing from the scope and essence of the embodiments of the present disclosure shall fall within the protection scope of the embodiments of the present disclosure.

1. A remote control reconnection method, applied to a server, the method comprising:
acquiring a reconnection request sent by a target controlled terminal device, wherein the reconnection request carries a reconnection persistent connection address and a reconnection pairing mark;
performing a matching determination on the reconnection pairing mark according to the reconnection persistent connection address and a preset pairing database, wherein the pairing database comprises an initial pairing mark and an initial control terminal device corresponding to the initial pairing mark;
taking the initial pairing mark matching the reconnection pairing mark as a target pairing mark, and taking the initial control terminal device corresponding to the target pairing mark as a target control terminal device; and
establishing a reconnection channel between the target control terminal device and the target controlled terminal device.

2. The method of claim 1, before acquiring the reconnection request sent by the target controlled terminal device, the method further comprising constructing the pairing database, comprising:
establishing a persistent connection with an initial controlled terminal device, generating an initial persistent connection address and the initial pairing mark, and sending the initial persistent connection address and the initial pairing mark to the initial controlled terminal device;
acquiring a remote control request from the initial control terminal device, wherein the remote control request carries a control persistent connection address and a control pairing mark;
establishing a persistent connection with the initial control terminal device according to the control persistent connection address, and performing the matching determination on whether the control pairing mark matches the initial pairing mark to obtain a control matching result;
in response to the control matching result indicating that the control pairing mark matches the initial pairing mark, establishing a control channel between the initial control terminal device and the initial controlled terminal device; and
constructing the pairing database according to the initial control terminal device, the initial controlled terminal device, and the initial pairing mark.

3. The method of claim 2, wherein the method comprises taking the initial controlled terminal device receives a disconnection signal as the target controlled terminal device, and the reconnection request is generated by the target controlled terminal device in the following means:
determining a disconnection status according to the disconnection signal; and
in response to the disconnection status indicating an abnormal disconnection, taking the initial persistent connection address as the reconnection persistent connection address, taking the initial pairing mark as the reconnection pairing mark, and generating the reconnection request according to the reconnection persistent connection address and the reconnection pairing mark.

4. The method of claim 3, wherein the reconnection request is sent by the target controlled terminal device in the following means:
determining a disconnection type according to the disconnection signal, and in response to the disconnection type indicating a network disconnection, detecting a network state to obtain a detection result; and
sending the reconnection request in response to the detection result indicating a network recovery.

5. The method of claim 4, wherein the means in which the target controlled terminal device sends the reconnection request further comprises:
sending the reconnection request in a preset request time interval in response to the disconnection type indicating a non-network disconnection.

6. The method according to claim 2, wherein before acquiring the reconnection request sent by the target controlled terminal device, the method further comprises:
acquiring video stream data sent by the initial controlled terminal device, wherein the video stream data is generated by the initial controlled terminal device after acquiring a preset permission and generating a virtual display according to the preset permission; and
sending the video stream data to the initial control terminal device.

7. The method of claim 1, wherein establishing the reconnection channel between the target control terminal device and the target controlled terminal device comprises:
acquiring a connection status of the target control terminal device; and
establishing the reconnection channel between the target control terminal device and the target controlled terminal device in response to the connection status being a connected status.

8. A remote control reconnection apparatus, applied to a server, the apparatus comprising:
a reconnection request acquisition module configured for acquiring a reconnection request sent by a target controlled terminal device, wherein the reconnection request carries a reconnection persistent connection address and a reconnection pairing mark;
a matching determination module configured for performing a matching determination on the reconnection pairing mark according to the reconnection persistent connection address and a preset pairing database, wherein the pairing database comprises an initial pairing mark and an initial control terminal device corresponding to the initial pairing mark;
a target control terminal device determining module configured for taking the initial pairing mark matching the reconnection pairing mark as a target pairing mark, and taking the initial control terminal device corresponding to the target pairing mark as a target control terminal device; and
a reconnection channel establishment module configured for establishing a reconnection channel between the target control terminal device and the target controlled terminal device.

9. An electronic device, comprising a memory and a processor, wherein the memory is configured for storing a computer program which, when executed by the processor, causes the processor to perform the method of claim 1.

10. A non-transitory computer-readable storage medium, having a computer program stored therein, wherein the computer program, when executed by a processor, causes the processor to perform the method of claim 1.

11. The electronic device of claim 9, before acquiring the reconnection request sent by the target controlled terminal device, the method further comprising constructing the pairing database, comprising:
establishing a persistent connection with an initial controlled terminal device, generating an initial persistent connection address and the initial pairing mark, and sending the initial persistent connection address and the initial pairing mark to the initial controlled terminal device;
acquiring a remote control request from the initial control terminal device, wherein the remote control request carries a control persistent connection address and a control pairing mark;
establishing a persistent connection with the initial control terminal device according to the control persistent connection address, and performing the matching determination on whether the control pairing mark matches the initial pairing mark to obtain a control matching result;
in response to the control matching result indicating that the control pairing mark matches the initial pairing mark, establishing a control channel between the initial control terminal device and the initial controlled terminal device; and
constructing the pairing database according to the initial control terminal device, the initial controlled terminal device, and the initial pairing mark.

12. The electronic device of claim 11, wherein the method comprises taking the initial controlled terminal device receives a disconnection signal as the target controlled terminal device, and the reconnection request is generated by the target controlled terminal device in the following means:
determining a disconnection status according to the disconnection signal; and
in response to the disconnection status indicating an abnormal disconnection, taking the initial persistent connection address as the reconnection persistent connection address, taking the initial pairing mark as the reconnection pairing mark, and generating the reconnection request according to the reconnection persistent connection address and the reconnection pairing mark.

13. The electronic device of claim 12, wherein the reconnection request is sent by the target controlled terminal device in the following means:
determining a disconnection type according to the disconnection signal, and in response to the disconnection type indicating a network disconnection, detecting a network state to obtain a detection result; and
sending the reconnection request in response to the detection result indicating a network recovery.

14. The electronic device of claim 13, wherein the means in which the target controlled terminal device sends the reconnection request further comprises:
sending the reconnection request in a preset request time interval in response to the disconnection type indicating a non-network disconnection.

15. The non-transitory computer-readable storage medium of claim 10, wherein the method comprises taking the initial controlled terminal device receives a disconnection signal as the target controlled terminal device, and the reconnection request is generated by the target controlled terminal device in the following means:
determining a disconnection status according to the disconnection signal; and
in response to the disconnection status indicating an abnormal disconnection, taking the initial persistent connection address as the reconnection persistent connection address, taking the initial pairing mark as the reconnection pairing mark, and generating the reconnection request according to the reconnection persistent connection address and the reconnection pairing mark.

16. The non-transitory computer-readable storage medium of claim 15, wherein the reconnection request is sent by the target controlled terminal device in the following means:
determining a disconnection type according to the disconnection signal, and in response to the disconnection type indicating a network disconnection, detecting a network state to obtain a detection result; and
sending the reconnection request in response to the detection result indicating a network recovery.

17. The non-transitory computer-readable storage medium of claim 16, wherein the means in which the target controlled terminal device sends the reconnection request further comprises:
sending the reconnection request in a preset request time interval in response to the disconnection type indicating a non-network disconnection.

18. The non-transitory computer-readable storage medium of claim 17, wherein the method comprises taking the initial controlled terminal device receives a disconnection signal as the target controlled terminal device, and the reconnection request is generated by the target controlled terminal device in the following means:
determining a disconnection status according to the disconnection signal; and
in response to the disconnection status indicating an abnormal disconnection, taking the initial persistent connection address as the reconnection persistent connection address, taking the initial pairing mark as the reconnection pairing mark, and generating the reconnection request according to the reconnection persistent connection address and the reconnection pairing mark.
